(19) United States
(12) Patent Application Publication
(10) Pub. No.: US 2023/0368349 A1
(43) Pub. Date: Nov. 16, 2023

(54) TEMPLATE IMAGE CREATION METHOD, TEMPLATE IMAGE CREATION SYSTEM, AND PROGRAM

(71) Applicant: Panasonic Intellectual Property Management Co., Ltd., Osaka (JP)

(72) Inventors: Yuya SUGASAWA, Osaka (JP); Yoshinori SATOU, Osaka (JP); Hisaji MURATA, Osaka (JP)

(21) Appl. No.: 18/248,019

(22) PCT Filed: Sep. 22, 2021
(86) PCT No.: PCT/JP2021/034891

§ 371 Date: Apr. 5, 2023

(30) Foreign Application Priority Data
Oct. 15, 2020 (JP) 2020-174231

(51) Int. Cl. G06T 5/50; G06T 7/33; G06T 7/00; G06V 10/74; G06T 5/00

(52) U.S. Cl. CPC G06T 5/50; G06T 7/33; G06T 7/97; G06V 10/761; G06T 5/002; G06T 2207/20221

(57) ABSTRACT

The template image creation method creates a template image from a plurality of candidate images each including a target region including an image of a test object. The template image creation method includes creating at least one template image by performing position correction by pattern matching to match a position of the target region between the plurality of candidate images and sequentially combining the plurality of candidate images.

### TECHNICAL FIELD

The present disclosure relates to a template image creation method, a template image creation system, and a program.

### BACKGROUND ART

An object recognition device is conventionally known which is configured to recognize objects using template matching. A template used in such an object recognition device is created by, for example, a template creation device of Patent Literature 1.

The template creation device acquires a plurality of templates from a plurality of images of different poses of a single object, or a plurality of images for a plurality of objects. The template creation device carries out a clustering process which computes a similarity score for an image feature for a combination of two templates selected from the plurality of templates and divides the plurality of templates into a plurality of groups on the basis of the similarity score. The template creation device carries out an integration process which, for each of the plurality of groups, combines all the templates in a group into a single integrated template or a number of integrated templates less than the number of templates within the group, and template creation device creates a new template set from the plurality of integrated templates corresponding to each group in the plurality of groups.

That is, a template creation device such as the template creation device described in Patent Literature 1 uses a plurality of acquired templates as a plurality of candidate images and divides the plurality of candidate images into a plurality of groups on the basis of similarity scores for the plurality of candidate images. The template creation device carries out an integration process which, for each of the plurality of groups, combines all the candidate images in a group into an integrated template, and the template creation device creates a new template set (a template image) from the plurality of integrated templates corresponding to each group in the plurality of groups.

The template creation device described above assumes that positions of a test object captured on the plurality of candidate images are aligned with each other. Therefore, when a template image is created from a plurality of candidate images in which positions of a test object are not aligned with each other, the template image has low accuracy and the template image includes a lot of noise, and thus, the template image is difficultly used in template matching.

### CITATION LIST

### Patent Literature

Patent Literature 1: JP 2016-207147 A

### SUMMARY OF INVENTION

It is an object of the present disclosure to provide a template image creation method, a template image creation system, and a program which are configured to create a highly accurate template image including little noise also when positions of a test object captured on a plurality of candidate images are not aligned with each other.

A template image creation method according to an aspect of the present disclosure creates a template image from a plurality of candidate images each including a target region including an image of a test object. The template image creation method includes creating at least one template image by performing position correction by pattern matching to match a position of the target region between the plurality of candidate images and sequentially combining the plurality of candidate images.

A template image creation system according to an aspect of the present disclosure creates a template image from a plurality of candidate images each including a target region including an image of a test object. The template image creation system includes an image processor configured to create at least one template image by performing position correction by pattern matching to match a position of the target region between the plurality of candidate images and sequentially combining the plurality of candidate images.

A program according to an aspect of the present disclosure is configured to cause a computer system to execute the template image creation method.

### BRIEF DESCRIPTION OF DRAWINGS

FIG. 1 is a view explaining template matching using a template image created by a template image creation method of an embodiment;

FIG. 2 is a block diagram of a template image creation system configured to perform the template image creation method;

FIG. 3 is a view of operation of the template image creation system;

FIG. 4 is a view of a gradation candidate image used in the template image creation method;

FIGS. 5A to 5D are enlarged views of part of the gradation candidate image;

FIG. 6 is a view of a binarization candidate image used in the template image creation method;

FIGS. 7A to 7D are enlarged views of part of the binarization candidate image;

FIG. 8 is a flowchart of an image process method of the embodiment;

FIG. 9 is a schematic diagram of the image process method;

FIG. 10 is a view of a template image created by the image process method;

FIG. 11 is a flowchart of an image process method of a first variation of the embodiment;

FIG. 12 is a flowchart of an image process method of a second variation of the embodiment;

FIG. 13 is a flowchart of an image process method of a fourth variation of the embodiment;

FIG. 14 is a schematic diagram of the image process method of the fourth variation;

FIG. 15 is a flowchart of an image process method of a sixth variation of the embodiment;

FIG. 16 is a view of a gradation candidate image of the sixth variation; and

FIG. 17 is a schematic diagram of the image process method of the sixth variation.

### DESCRIPTION OF EMBODIMENTS

An embodiment descried below generally relates to template image creation methods, template image creation systems, and programs. The embodiment described below more specifically relates to a template image creation method, a template image creation system, and a program which create a template image from a plurality of candidate images. Note that the embodiment described below is a mere example of embodiments of the present disclosure. The present disclosure is not limited to the embodiment described below, but various modifications may be made to the embodiment described below depending on design and the like as long as the effect of the present disclosure is provided.

### (1) Template Matching

Template matching using an image process technique is applied to a test object inspection and a pre-process of the inspection. Examples of the inspection are a mounting inspection of inspecting whether or not a specific component is mounted at a location on a printed circuit board as designed, a processing inspection of inspecting whether or not a product is processed to have a dimension and a shape as designed, an assembling inspection of inspecting whether or not a product is assembled as designed, or an exterior inspection of inspecting whether or not a specific component has a feature examples of which are scratches and stains. In the template matching, a standard pattern which is a normal pattern (feature) of the structure of a test object is created as a template image in advance, and the template image is applied to a captured image obtained by capturing an image of the test object, thereby performing pattern matching.

In the present embodiment, a Micro Electro Mechanical Systems (MEMS) device is assumed to be a test object, and an inner structure of the MEMS device is inspected.

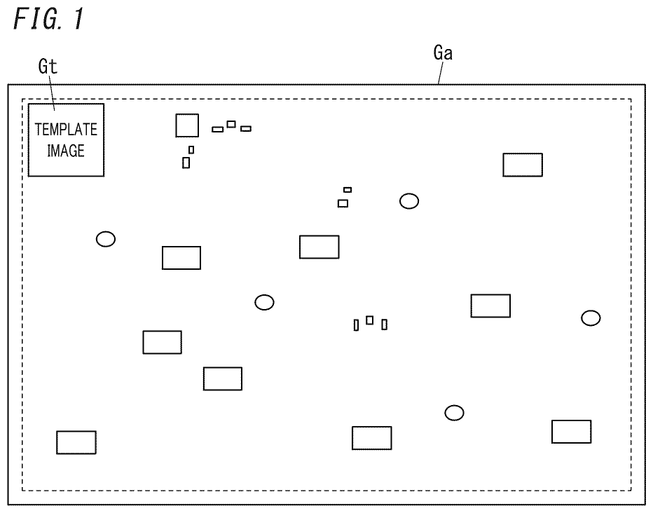

An inspection device configured to perform a structure inspection on the MEMS device by template matching applies a template image Gt which is rectangular to an inspection image Ga which is rectangular shown in FIG. 1. The size of the template image Gt is smaller than the size of the inspection image Ga. Then, each time inspection device moves the template image Gt by a raster scan and the like within a search range of the inspection image Ga, the inspection device obtains a similarity between the template image Gt and part of the inspection image Ga on which the template image Gt overlaps. The inspection device can use, as a detection position, a position at which the similarity is highest within the search range, thereby performing the structure inspection at the detection position.

In the template matching, the template image Gt is created based on a captured image obtained by capturing an image of a non-defective product or a defective product. The template image Gt is required to accurately reflect features of the non-defective product and include little noise.

Therefore, in the present embodiment, the template image Gt is created a template image creation method executed by the template image creation system described below.

### (2) Template Image Creation System

### (2.1) System Configuration

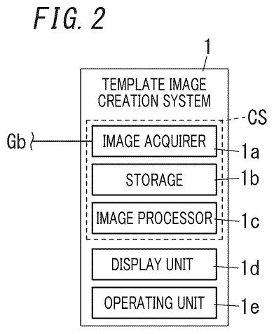

A template image creation system 1 includes a computer system CS, a display unit 1d, and an operating unit 1e as shown in FIG. 2. The computer system CS includes an image acquirer 1a, a storage 1b, and an image processor 1c.

In the computer system CS, a processor of a Central Processing Unit (CPU), a Micro Processing Unit (MPU), or the like reads, and executes, a program of a vibration inspection method stored in memory, thereby implementing some or all of functions of the template image creation system 1. The computer system CS includes, as a main hardware component, the processor, which operates in accordance with the program. The type of the processor is not particularly limited, as long as the processor executes the program to implement the function(s). The processor may be implemented as a single electronic circuit or a plurality of electronic circuits including a semiconductor integrated circuit (IC) or a large-scale integrated (LSI) circuit. The integrated circuit such as IC or LSI mentioned herein may be referred to in another way, depending on the degree of the integration and may be an integrated circuit called system LSI, very-large-scale integration (VLSI), or ultra-large-scale integration (ULSI). A field programmable gate array (FPGA), which is programmable after fabrication of the LSI, or a logical device which allows set-up of connections in LSI or reconfiguration of circuit cells in LSI may be used in the same manner. Those electronic circuits may be either integrated together on a single chip or distributed on multiple chips, whichever is appropriate. Those multiple chips may be integrated together in a single device or distributed in multiple devices without limitation.

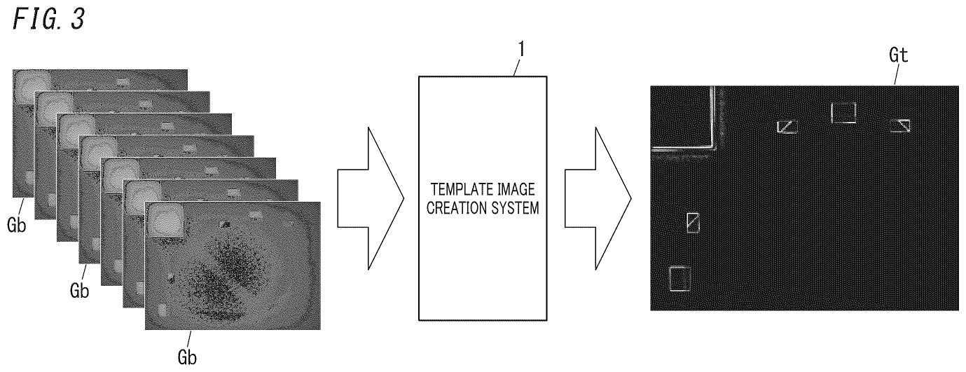

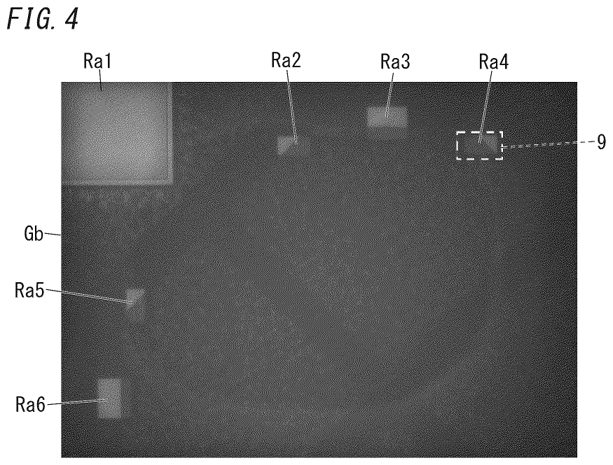

The template image creation system 1 acquires a plurality of captured images each having the same size as the template image Gt as a plurality of gradation candidate images Gb as shown in FIG. 3. The gradation candidate images Gb are rectangular images based on which the template image Gt is to be created. FIG. 4 shows an example of the gradation candidate images Gb. Each gradation candidate image Gb is a gradation image obtained by capturing an image of an interior of the MEMS device which is a non-defective product or a defective product, and this gradation image includes an image of a specific element constituting a part of the interior of the MEMS device. Each gradation candidate image Gb includes target regions Ra1 to Ra6 as regions (target regions Ra) each including an image of the specific element constituting the part of the interior of the MEMS device. The target regions Ra1 to Ra6 are lighter than regions surrounding the target regions Ra1 to Ra6. The gradation image is an image in which gradation values are set in, for example, 256 levels. Note that in the gradation image of the present embodiment, dark pixels have small gradation values, whereas light pixels have high gradation values. Moreover, the gradation image can be either a monochrome image or a color image.

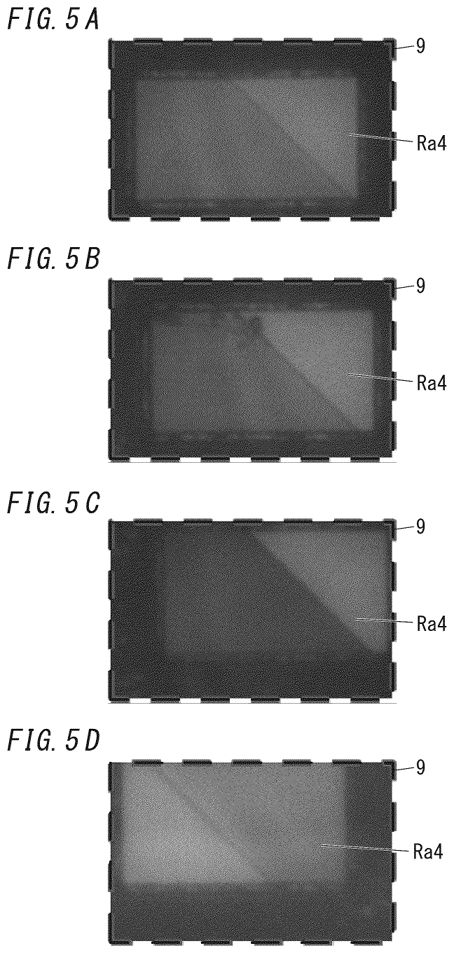

The template image creation system 1 obtains the plurality of gradation candidate images Gb and performs image processing on the plurality of gradation candidate images Gb, thereby creating the template image Gt. However, positions of the target regions Ra1 to Ra6 are not aligned between the plurality of gradation candidate images Gb. For example, the target regions Ra4 with respect to a rectangular range 9 located at predetermined coordinates of an inspection space may be displaced from one another as shown in FIGS. 5A to 5D. When the template image Gt is created from the plurality of gradation candidate images Gb displaced from each other in terms of the positions of the target regions Ra1 to Ra6, the template image Gt is more likely to include noise.

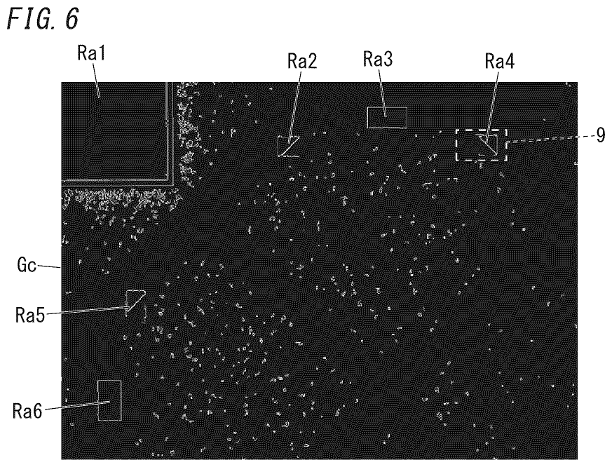

Moreover, subjecting the gradation candidate image Gb shown in FIG. 4 to a binarization process and an edge detection process creates a binarization candidate image Gc in which edges of the target regions Ra1 to Ra4 in the gradation candidate image Gb are extracted as shown in FIG. 6. Thus, subjecting the plurality of binarization candidate images Gc to the image processing can also create the template image Gt. However, similarly to the gradation candidate images Gb, the positions of the target regions Ra1 to Ra6 are not aligned between the plurality of binarization candidate images Gc. When the template image Gt is created from the plurality of binarization candidate images Gc displaced from each other in terms of the positions of the target regions Ra1 to Ra6, the template image Gt is more likely to include noise.

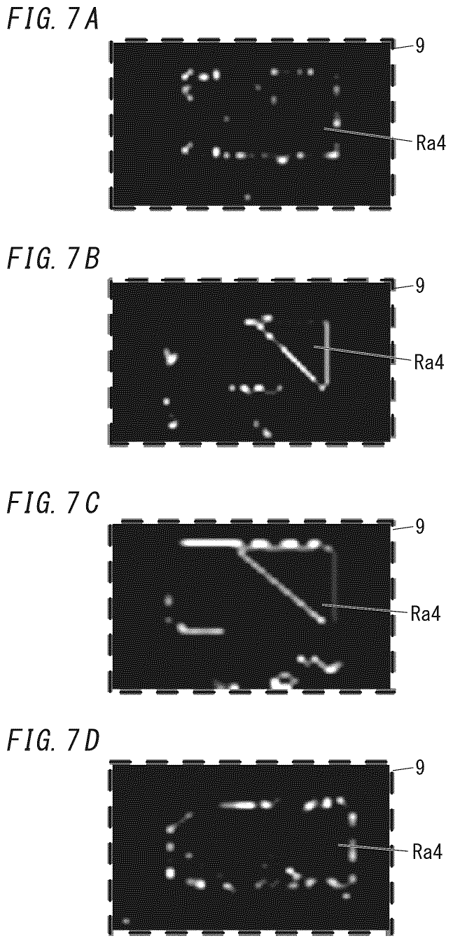

Moreover, the edges of the target regions Ra1 to Ra4 are extracted in the binarization candidate image Gc, but some of the edges are erroneously extracted and some edges are missing. That is, when a lot of noise is included in the gradation candidate image Gb, noise which is removable by neither the binarization process nor the edge detection process may remain in the binarization candidate image Gc. For example, as shown in FIGS. 7A to 7D, some of the edges of the target regions Ra4 within the rectangular range 9 are erroneously extracted and some edges of the target regions Ra4 within the rectangular range 9 are missing. When the template image Gt is created from the plurality of binarization candidate images Gc in which some of the edges of the target regions Ra1 to Ra6 are erroneously extracted and some edges of the target regions Ra1 to Ra6 are missing, the template image Gt is more likely to include noise.

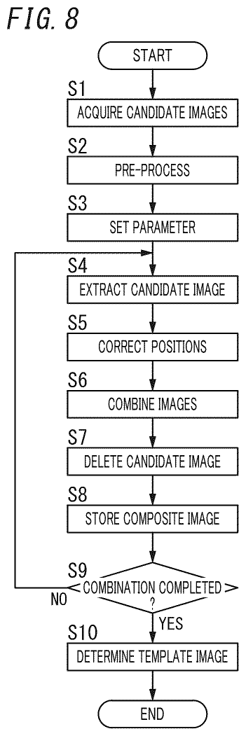

Therefore, the template image creation system 1 creates the template image Gt from the plurality of gradation candidate images Gb in accordance with the flowchart shown in FIG. 8.

### (2.2) Template Image Creation Method

FIG. 8 shows the template image creation method executed by the computer system CS of the template image creation system 1.

First of all, the image acquirer 1a acquires N+1 gradation candidate images Gb from an external database, a camera, a storage medium, or the like (acquisition step S1). Note that N is a positive integer.

The image processor 1c pre-processes each of the N+1 gradation candidate images Gb (pre-processing step S2). The pre-process of the present embodiment includes the binarization process and the edge detection process. In this case, the image processor 1c subjects each of the N+1 gradation candidate images Gb to the binarization process and the edge detection process, thereby creating N+1 binarization candidate images Gc, and stores pieces of data on the N+1 binarization candidate images Gc in the storage 1b. That is, the storage 1b stores the pieces of data on the N+1 binarization candidate images Gc. Note that the pre-process includes at least one of a median filter process, a Gaussian filter process, a histogram equalization process, a normalization process, a standardization process, or the like.

The storage 1b preferably includes at least one of a Solid State Drive (SSD), a Hard Disk Drive (HDD), or rewritable memory such as Electrically Erasable Programmable Read Only Memory (EEPROM), Random-Access Memory (RAM), or flash memory.

Next, the image processor 1c performs a parameter setting process (parameter setting step S3). The parameter setting step S3 includes setting a parameter relating to position correction. Regarding a displacement of the gradation candidate images Gb, directions in which the displacement is more likely to occur differ depending on test objects. The directions in which the displacement is more likely to occur include a direction along the long side of the gradation candidate image Gb, a direction along the short side of the gradation candidate image Gb, and a rotation direction. Moreover, the parameter may include perspective correction, zooming in, and zooming out of an image. Thus, the parameter setting step S3 includes setting the direction in which the displacement of the gradation candidate images Gb is more likely to occur as a parameter for each test object.

Next, the image processor 1c sequentially extracts one binarization candidate image Gc from the N+1 binarization candidate images Gc (extraction step S4). Specifically, the N+1 binarization candidate images Gc are assumed to be binarization candidate images Gc(1), Gc(2), Gc(3), . . . Gc(N+1), and in this case, each time the image processor 1c performs the process of the extraction step S4, the image processor 1c extracts one binarization candidate image Gc in order of the binarization candidate images Gc(1), Gc(2), Gc(3), . . . . Here, the extraction step S4 is performed for the first time, and therefore, the image processor 1c extracts the binarization candidate image Gc(1). The binarization candidate image Gc extracted in the extraction step S4 is only the binarization candidate image Gc(1), and therefore, the image processor 1c does not execute processes of subsequent steps S5, S6, and S8 and deletes the data on the binarization candidate image Gc(1) from the storage 1b (data deleting step S7). Then, the image processor 1c determines whether or not combining all the binarization candidate images Gc(1), Gc(2), Gc(3), . . . is completed (completion determining step S9).

Since the combining all the binarization candidate images Gc(1), Gc(2), Gc(3), . . . is not completed, the image processor 1c performs the process of the extraction step S4 again. Here, the extraction step S4 is performed for the second time, and therefore, the image processor 1c extracts the binarization candidate image Gc(2). Thus, the image processor 1c extracts the binarization candidate images Gc(1) and Gc(2) by the process of the extraction step S4 respectively performed for the first and second times.

Next, the image processor 1c performs the position correction of the binarization candidate images Gc(1) and Gc(2) (position correcting step S5). Specifically, the image processor 1c performs the position correction by the pattern matching to match the positions of the target regions Ra1 to Ra6 of the binarization candidate image Gc(1) and the positions of the target regions Ra1 to Ra6 of the binarization candidate image Gc(2) with each other, respectively. The pattern matching includes adjusting the positions of the binarization candidate images Gc(1) and Gc(2) on inspection coordinates such that a similarity between the binarization candidate images Gc(1) and Gc(2) on the inspection coordinates is maximum. In other words, the image processor 1c adjusts the positions of the binarization candidate images Gc(1) and Gc(2) such that the positions of the target regions Ra1 to Ra6 of the binarization candidate image Gc(1) and the positions of the target regions Ra1 to Ra6 of the binarization candidate image Gc(2) are aligned with each other, respectively. At this time, the image processor 1c adjusts the positions of the binarization candidate images Gc(1) and Gc(2) along only the direction set as the parameter in the parameter setting step S3. Thus, the image processor 1c enables the direction for the position correction to be limited, thereby suppressing a calculation cost required for the position correction. Hereinafter, the position correction in the position correcting step S5 is performed along only the direction set as the parameter.

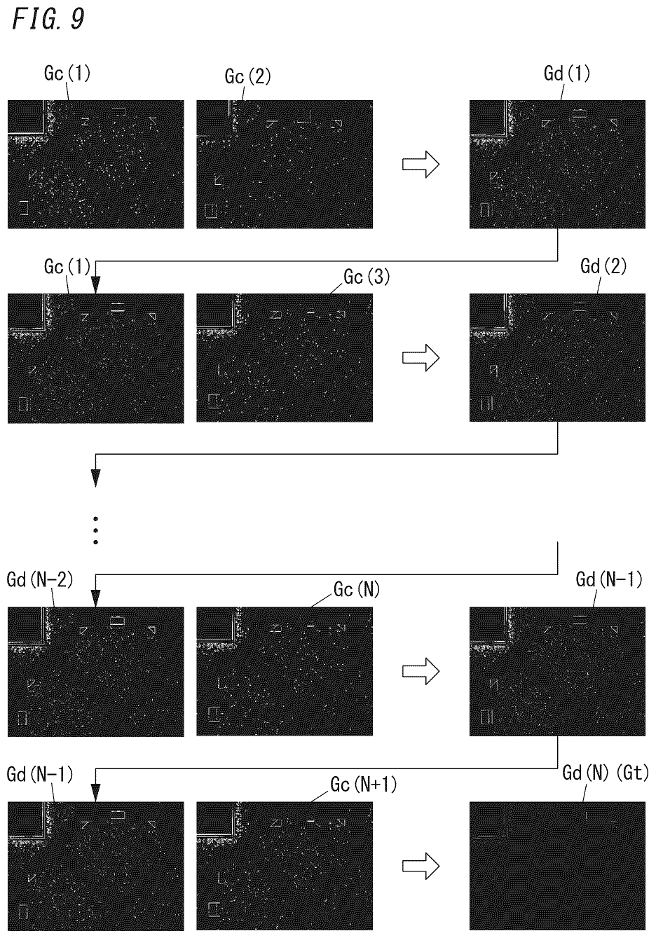

Next, the image processor 1c combines the binarization candidate images Gc(1) and Gc(2) together after the position correction, thereby creating a composite image Gd(1) (see FIG. 9) (compositing step S6). In the compositing step S6, the gradation value of each of pixels of the composite image is an average value of gradient values, a weighted average value, a median value, a logical disjunction, or a logical conjunction of pixels of each of the two binarization candidate images. In the composite image Gd(1), the target regions Ra1 to Ra6 of the binarization candidate image Gc(1) and the target regions Ra1 to Ra6 of the binarization candidate image Gc(2) are combined with each other, respectively, thereby forming target regions Ra1 to Ra6 of the composite image Gd(1).

The image processor 1c deletes the data on the binarization candidate image Gc(2) from the storage 1b (data deleting step S7). The image processor 1c stores data on the composite image Gd(1) in the storage 1b (data storing step S8). As a result, the storage 1b stores the pieces of data on the binarization candidate images Gc(3) to Gc(N+1) and the composite image Gd(1). Then, the image processor 1c determines whether or not the combining all the binarization candidate images Gc(1), Gc(2), Gc(3), . . . is completed (completion determining step S9).

Since the combining all the binarization candidate images Gc(1), Gc(2), Gc(3), . . . is not completed, the image processor 1c performs the process of the extraction step S4 again. Here, the extraction step S4 is performed for the third time, and therefore, the image processor 1c extracts the binarization candidate image Gc(3). Thus, the image processor 1c extracts the binarization candidate images Gc(1) to Gc(3) by the process of the extraction step S4 performed for the first to third times.

Next, the image processor 1c performs the position correction of the composite image Gd(1) and the binarization candidate image Gc(3) (position correcting step S5). Specifically, the image processor 1c performs the position correction by the pattern matching to match the positions of the target regions Ra1 to Ra6 of the composite image Gd(1) and the positions of the target regions Ra1 to Ra6 of the binarization candidate image Gc(3) with each other, respectively.

Next, the image processor 1c combines the composite image Gd(1) and the binarization candidate image Gc(3) together after the position correction, thereby creating a composite image Gd(2) (see FIG. 9) (compositing step S6). Here, the composite image Gd(1) is a composite image of two images, namely, the binarization candidate images Gc(1) and Gc(2), and the binarization candidate image Gc(3) is a single binarization candidate image. Therefore, when the image processor 1c uses an average of gradation values of pixels of the composite image Gd(1) and the binarization candidate image Gc(3) as the gradation value of each of pixels of the composite image Gd(2), the image processor 1c preferably performs a weighted averaging process on the gradation values of the pixels of the composite image Gd(1) and the binarization candidate image Gc(3). In the composite image Gd(2), the target regions Ra1 to Ra6 of the composite image Gd(1) and the target regions Ra1 to Ra6 of the binarization candidate image Gc(3) are combined with each other, respectively, thereby forming target regions Ra1 to Ra6 of the composite image Gd(2). Note that the composite image Gd(2) can be said to be an image obtained by combining the binarization candidate images Gc(1) to Gc(3) together.

The image processor 1c deletes the pieces of data on the composite image Gd(1) and the binarization candidate image Gc(3) from the storage 1b (data deleting step S7). The image processor 1c stores data on the composite image Gd(2) in the storage 1b (data storing step S8). As a result, the storage 1b stores the pieces of data on the binarization candidate images Gc(4) to Gc(N+1) and the composite image Gd(2). Then, the image processor 1c determines whether or not the combining all the binarization candidate images Gc(1), Gc(2), Gc(3), . . . is completed (completion determining step S9).

Since the combining all the binarization candidate images Gc(1), Gc(2), Gc(3), . . . is not completed, the image processor 1c performs the process of the extraction step S4 again. Hereafter, the image processor 1c repeatedly performs the processes of the extraction step S4 to the completion determining step S9, thereby creating the composite images Gd(3) to Gd(N).

That is, the extraction step S4 includes extracting an Mth binarization candidate image Gc(M) (where M is a positive integer less than or equal to N) from the N+1 binarization candidate images Gc(1)to Gc(N+1). The position correcting step S5 includes performing the pattern matching to match the positions of the target regions Ra1 to Ra6 of a composite image Gd(M−2) obtained by combining the first to (M−1)th binarization candidate images Gc(1) to Gc(M−1) together and the positions of the target regions Ra1 to Ra6 of the Mth binarization candidate image Gc(M) with each other, respectively. The compositing step S6 includes combining the composite image Gd(M−2) and the Mth binarization candidate image Gc(M) together.

Then, the image processor 1c performs the process of the extraction step S4 for the (N+1)th time and then creates the composite image Gd(N). In this case, the combining all the binarization candidate images Gc(1), Gc(2), Gc(3), . . . is completed, and thus, the image processor 1c uses the composite image Gd(N) as the template image Gt (determination step S10) (see FIG. 9). That is, the image processor 1c uses, as the template image Gt, the composite image Gd(N) created in the compositing step S6 performed for the last time. The image processor 1c stores data on the template image Gt in the storage 1b.

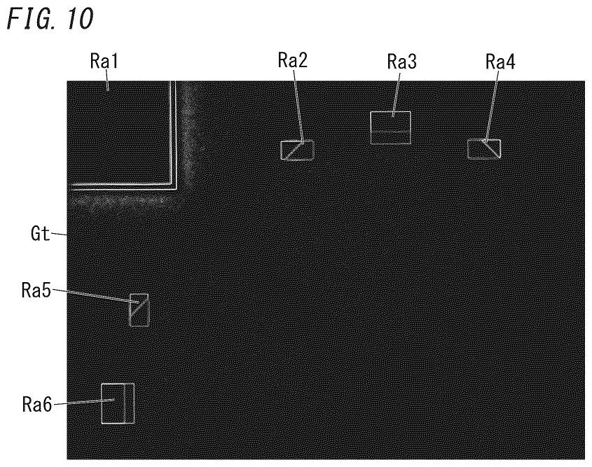

FIG. 10 shows an example of the template image Gt. In the template image Gt, the edges of the target regions Ra1 to Ra6 are suppressed from being missing and from being erroneously extracted and are thus clear as compared with the binarization candidate image Gc (see FIG. 6), and therefore, the template image Gt is a highly accurate template image. Moreover, the template image Gt includes less noise than the binarization candidate image Gc (see FIG. 6).

The computer system CS outputs the data on the template image Gt to the display unit 1d. The display unit 1d is a liquid crystal display, an organic EL display, or the like and displays the template image Gt. Thus, an inspector views the template image Gt displayed on the display unit 1d, thereby visually recognizing the template image Gt to be used for the inspection.

The operating unit 1e has a user interface function for receiving an operation given by the inspector. The operating unit 1e includes at least one user interface such as a touch screen, a keyboard, and a mouse. The inspector gives, to the operating unit 1e, operations, for example, to activate the computer system CS, input settings of the parameter relating to the position correction in the parameter setting step S3, and control display of the display unit 1d.

As described above, the template image creation method of the present embodiment creates the template image Gt from the plurality of binarization candidate images Gc displaced from each other in terms of the positions of the target regions Ra1 to Ra6. Specifically, the template image creation method of the present embodiment includes sequentially combining the plurality of binarization candidate images Gc together after the displacement of the plurality of binarization candidate images Gc is corrected by the position correction using the pattern matching, thereby creating the template image Gt. As a result, the template image creation method of the present embodiment enables a highly accurate template image Gt including little noise to be created also when positions of the test object captured on the plurality of binarization candidate images Gc are not aligned with each other. Here, “sequentially combine the plurality of images” means sequentially and repeatedly perform the process of combining some images of a plurality of images without combining all of the plurality of images at once.

Note that in the present embodiment, the binarization candidate image Gc is an image obtained by subjecting the gradation candidate image Gb to the binarization process and the edge detection process, and each of the gradation candidate image Gb and the binarization candidate image Gc is a candidate image including pieces of information on the target regions Ra1 to Ra6. That is, the gradation candidate image Gb and the binarization candidate image Gc can be regarded as candidate images of the present disclosure.

### (3) First Variation

In a template image creation method of a first variation, whether or not combining the plurality of binarization candidate images Gc is allowable is set based on a similarity or similarities of the plurality of binarization candidate images Gc to each other. In this way, optimizing determination of whether or not the combining the plurality of binarization candidate images Gc is allowable enables a highly accurate template image Gt including little noise to be created also when the plurality of binarization candidate images Gc include a binarization candidate image Gc including a lot of noise.

Note that the similarity may be the goodness of fit of pattern matching or may alternatively be obtained by comparing feature amounts of the candidate images with each other, where the feature amounts are feature amounts extracted by deep learning, histograms of the gradation values of pixels, histogram statistics, results of blob detection, the lengths of the edges of the target regions Ra, or the like. Examples of the method for comparing the feature amounts with each other include a Euclidean distance, an isolation index, and a bray-curtis index.

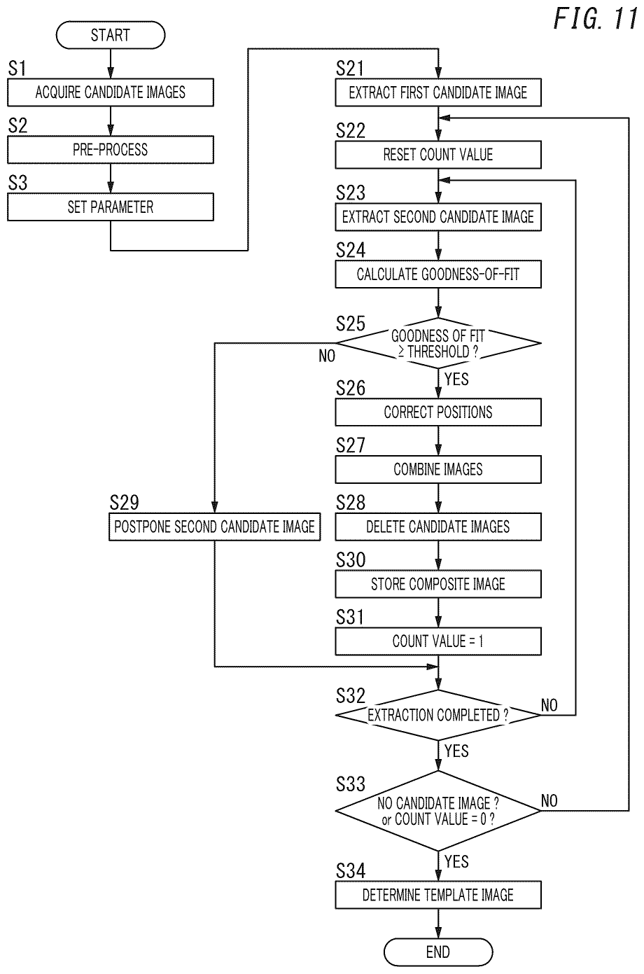

FIG. 11 is a flowchart of the template image creation method of the first variation.

First of all, the computer system CS performs an acquisition step S1, a pre-processing step S2, and a parameter setting step S3 in the same manner as explained above.

Then, the image processor 1c extracts one binarization candidate image Gc as a first candidate image from N+1 binarization candidate images Gc (Gc(1) to Gc(N+1)) (extraction step S21). Here, the image processor 1c extracts a binarization candidate image Gc(1) as the first candidate image. Then, the image processor 1c resets the value (count value) of a counter included in the computer system CS to 0 (reset step S22).

Next, the image processor 1c extracts one binarization candidate image Gc as a second candidate image from N binarization candidate images Gc(2) to Gc(N+1) except for the binarization candidate image Gc(1) (extraction step S23). Here, the image processor 1c extracts the binarization candidate image Gc(2) as the second candidate image.

Next, the image processor 1c obtains the goodness of fit of the pattern matching in the binarization candidate images Gc(1) and Gc(2) (goodness-of-fit calculating step S24). When a large number of binarization candidate images Gc are used, similarities of the binarization candidate images Gc to each other may be obtained by using a feature amount extracting method and a feature amount comparing method instead of obtaining the goodness of fit of the pattern matching. Examples of the comparison between the feature amounts include a Euclidean distance, an isolation index, and a bray-curtis index.

Next, the image processor 1c determines whether or not the goodness of fit between the binarization candidate images Gc(1) and Gc(2) is greater than or equal to a matching threshold (matching determining step S25). That is, in the matching determining step S25, the image processor 1c sets, based on a similarity between the binarization candidate images Gc(1) and Gc(2), whether or not combining the binarization candidate images Gc(1) and Gc(2) is allowable. Note that the matching threshold may be a preset value. Alternatively, the matching threshold may be set from distribution of degrees of the template matching in a plurality of binarization candidate images Gc, that is, for example, after a predetermined number of times of repetitions of selecting the plurality of binarization candidate images Gc and storing the goodness of fit of the plurality of binarization candidate images Gc thus selected, the value of the top 50% of the goodness of fit may be used as the matching threshold.

Next, if the goodness of fit is greater than or equal to the matching threshold, the image processor 1c performs the position correction of the binarization candidate images Gc(1) and Gc(2) by the pattern matching (position correcting step S26). At this time, the image processor 1c adjusts the positions of the binarization candidate images Gc(1) and Gc(2) along only the direction set as the parameter in the parameter setting step S3. Thus, the image processor 1c enables the direction for the position correction to be limited, thereby suppressing a calculation cost required for the position correction. Hereinafter, the position correction in the position correcting step S26 is performed along only the direction set as the parameter.

Next, the image processor 1c combines the binarization candidate images Gc(1) and Gc(2) together after the position correction, thereby creating a composite image Gd(1) (compositing step S27). Then, the image processor 1c deletes pieces of data on the binarization candidate images Gc(1) and Gc(2) thus combined with each other from the storage 1b (data deleting step S28) and stores data on the composite image Gd(1) in the storage 1b (data storing step S30). As a result, the storage 1b stores the pieces of data on the binarization candidate images Gc(3) to Gc(N+1) and the composite image Gd(1). Then, the image processor 1c sets the count value to 1 (count step S31).

If the goodness of fit is less than the matching threshold, the image processor 1c postpones a compositing process using the binarization candidate image Gc(2) which is the second candidate image (postponing step S29). In this case, the storage 1b stores pieces of data on the binarization candidate images Gc(2) to Gc(N+1).

Then, the image processor 1c determines whether or not extracting all the binarization candidate images Gc(1) to Gc(N+1) is completed (completion determining step S32). Since the extracting all the binarization candidate images Gc(1) and Gc(2), Gc(3), is not completed, the image processor 1c performs the process of the extraction step S23 again. In the extraction step S23, the image processor 1c uses the composite image Gd(1) or the binarization candidate image Gc(1) as the first candidate image, and in addition, the image processor 1c extracts the binarization candidate image Gc(3) as the second candidate image.

Next, the image processor 1c obtains the goodness of fit of the pattern matching in the first candidate image and the binarization candidate image Gc(3) (goodness-of-fit calculating step S24).

Next, the image processor 1c determines whether or not the goodness of fit between the first candidate image and the binarization candidate image Gc(3) is greater than or equal to a matching threshold (matching determining step S25). That is, in the matching determining step S25, the image processor 1c sets, based on a similarity between the first candidate image and the binarization candidate image Gc(3), whether or not combining the first candidate image and the binarization candidate image Gc(3) is allowable.

Next, if the goodness of fit is greater than or equal to the matching threshold, the image processor 1c performs the position correction of the first candidate image and the binarization candidate image Gc(3) by the pattern matching (position correcting step S26). The image processor 1c combines the first candidate image and the binarization candidate image Gc(3) together after the position correction, thereby creating a composite image Gd(2) (compositing step S27). Then, the image processor 1c deletes the pieces of data on the first candidate image and the binarization candidate image Gc(3) thus combined with each other from the storage 1b (data deleting step S28) and stores data on the composite image Gd(2) in the storage 1b (data storing step S30). Then, the image processor 1c sets the count value to 1 (count step S31).

If the goodness of fit is less than the matching threshold, the image processor 1c postpones the compositing process using the binarization candidate image Gc(3) which is the second candidate image (postponing step S29).

Then, the image processor 1c determines whether or not extracting all the binarization candidate images Gc(1) to Gc(N+1) is completed (completion determining step S32). Since the extracting all the binarization candidate images Gc(1) and Gc(2), Gc(3), . . . is not completed, the image processor 1c performs the process of the extraction step S23 again. In the extraction step S23, the image processor 1c uses the composite image Gd(2) or the binarization candidate image Gc(1) as the first candidate image and additionally extracts the binarization candidate image Gc(4) as the second candidate image. Hereafter, the image processor 1c repeatedly performs the processes from the extraction step S23 to the completion determining step S32.

Then, once the extracting all the binarization candidate images Gc(1) and Gc(2), Gc(3), . . . is completed in the completion determining step S32, the image processor 1c determines whether or not the count value is 0 and whether or not a postponed binarization candidate image Gc remains (end determination step S33).

The image processor 1c determines the template image Gt if at least one of the following two conditions is satisfied (determination step S34). The storage 1b stores no binarization candidate image Gc but stores only one composite image Gd The count value is 0.

Specifically, if the storage 1b stores no binarization candidate image Gc but stores only one composite image Gd in the end determination step S33, combining all the binarization candidate images Gc(1), Gc(2), Gc(3), . . . is completed, and the image processor 1c determines that the composite image Gd(N) is the template image Gt (determination step S34).

Moreover, when the binarization candidate images Gc(1) and Gc(2), Gc(3), . . . are sequentially combined with each other, the composite image Gd is not updated if all the goodness of fit obtained in the goodness-of-fit calculating step S24 are each less than the matching threshold. In this case, returning to the reset step S22 to perform the processes of the reset step S22 and subsequent steps again is not necessary. Therefore, the count value is used as a value for determining the necessity of performing the processes of the reset step S22 and subsequent steps. If all the goodness of fit obtained in the goodness-of-fit calculating step S24 are each less than the matching threshold, the count value is 0. Thus, if the count value is 0 in the end determination step S33, the image processor 1c determines that the composite image Gd at that time point is the template image Gt or determines that the template image Gt fails to be created (determination step S34).

Moreover, if the count value is 1 (if the count value is not 0) in the end determination step S33, the composite image Gd is created, and noise included in the composite image Gd is expected to be less than noise included in the candidate image. Thus, if the count value is 1 and the storage 1b stores the binarization candidate image Gc, the image processor 1c determines that a postponed binarization candidate image Gc remains, and the image processor 1c returns to the reset step S22 to perform the processes of the reset step S22 and subsequent steps again. Then, the image processor 1c uses the composite image Gd at this time point as the first candidate image and uses the postponed binarization candidate image Gc as the second candidate image (extraction step S23), and the image processor 1c performs the processes of the goodness-of-fit calculating step S24 and subsequent steps.

Alternatively, after repeating the determination process of the end determination step S33 a predetermined maximum number of times, the image processor 1c may determine that the composite image Gd at this time point is the template image Gt, even if a postponed binarization candidate image Gc still remains (determination step S34).

Thus, in the template image creation method of the present variation, a binarization candidate image(s) Gc of the binarization candidate images Gc(1) to Gc(N+1) which is significantly different from the other(s) of the binarization candidate images Gc(1) to Gc(N+1) is excluded from the binarization candidate images Gc(1) to Gc(N+1), and therefore, the template image creation method can create a highly accurate template image Gt including little noise.

### (4) Second Variation

In a template image creation method of a second variation, whether or not combining the plurality of binarization candidate images Gc is allowable is set based on a similarity or similarities of the plurality of binarization candidate images Gc to each other. In this way, optimizing determination of whether or not the combining the plurality of binarization candidate images Gc is allowable enables a highly accurate template image Gt including little noise to be created also when the plurality of binarization candidate images Gc include a binarization candidate image Gc including a lot of noise.

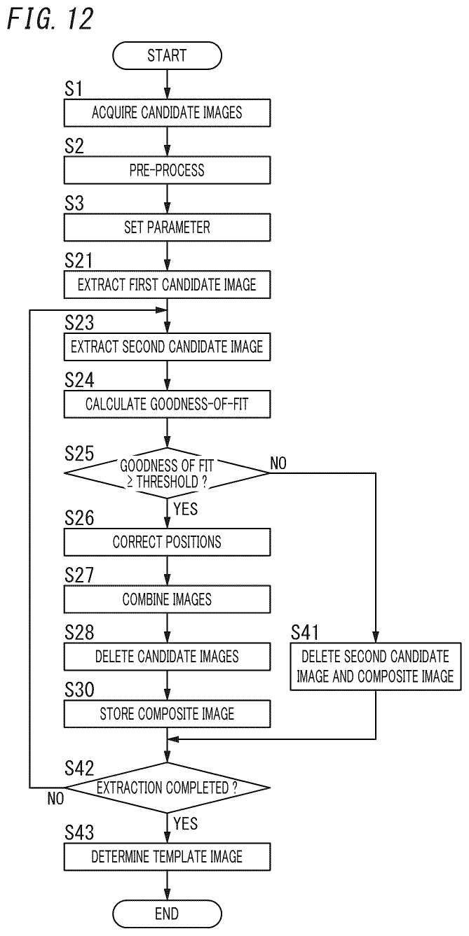

FIG. 12 is a flowchart of the template image creation method of the second variation.

In the second variation, the acquisition step S1, the pre-processing step S2, the parameter setting step S3, the extraction step S21, the extraction step S23, the goodness-of-fit calculating step S24, and the matching determining step S25 in the flowchart of the first variation shown in FIG. 11 are performed.

Processes of the matching determining step S25 and subsequent steps of the second variation will be described below.

The image processor 1c obtains a goodness of fit of the pattern matching in a composite image Gd and determines whether or not the goodness of fit is greater than or equal to a matching threshold (matching determining step S25). That is, in the matching determining step S25, the image processor 1c sets, based on a similarity between a first candidate image and a second candidate image, whether or not combining the first candidate image and the second candidate image is allowable.

If the goodness of fit is greater than or equal to the matching threshold, the image processor 1c performs the position correcting step S26, the compositing step S27, the data deleting step S28, and the data storing step S30 in a similar manner to the first variation.

If the goodness of fit is less than the matching threshold, the image processor 1c deletes data on the second candidate image from the storage 1b (data deleting step S41).

Then, the image processor 1c determines whether or not extracting all the binarization candidate images Gc(1), Gc(2), Gc(3), . . . is completed (completion determining step S42). If the extracting all the binarization candidate images Gc(1), Gc(2), Gc(3), . . . is not completed, the image processor 1c performs the process of the extraction step S23 again If the extraction of all the binarization candidate images Gc(1), Gc(2), Gc(3), . . . is completed, the image processor 1c determines that the composite image Gd at this time point is the template image Gt (determination step S43).

Thus, the template image creation method of the present variation can create the highly accurate template image Gt including little noise also when the binarization candidate images Gc(1) to Gc(N+1) include a binarization candidate image(s) Gc significantly different from the other(s) of the binarization candidate images Gc(1) to Gc(N+1).

### (5) Third Variation

In a template image creation method of a third variation, the extraction step S4 of the flowchart in FIG. 8 preferably includes setting, based on a similarity or similarities of a plurality of binarization candidate images Gc to each other, a sequential order of combining the plurality of binarization candidate images Gc. In this way, optimizing the sequential order of combining the plurality of binarization candidate images Gc enables a highly accurate template image Gt including little noise to be created also when the plurality of binarization candidate images Gc include a binarization candidate image Gc including a lot of noise.

Specifically, the image processor 1c uses one binarization candidate image Gc of N+1 binarization candidate images Gc as a reference image. In this variation, a binarization candidate image Gc(1) is used as the reference image. Then, the image processor 1c obtains similarities of each of the binarization candidate images Gc(2) to Gc(N+1) to the binarization candidate image Gc(1). The image processor 1c assigns sequential orders to the binarization candidate images Gc(2) to Gc(N+1) in descending order of similarity. That is, the image processor 1c assigns the rank order “1” to the binarization candidate image Gc(1) and assigns the rank orders “2”, “3”, . . . , “N+1” respectively to the binarization candidate images Gc(2) to Gc(N+1) in order of similarity to the binarization candidate image Gc(1). The smaller the numerical digit of the rank order, the higher the rank order is. Each time the image processor 1c executes the extraction step S4, the image processor 1c extracts one binarization candidate image Gc from the N+1 binarization candidate images Gc in order of “1”, “2”, “3”, . . . , “N+1” from a higher rank order toward a lower rank order. If the binarization candidate images Gc(1) to Gc(N+1) include a binarization candidate image(s) Gc significantly different from the other(s) of the binarization candidate images Gc(1) to Gc(N+1), executing the pattern matching of the position correcting step S5 by using the binarization candidate image(s) Gc results in a low similarity. If the similarity is lower than the predetermined threshold, the image processor 1c stops the subsequent processes and determines that a composite image Gd(M) at this time point is the template image Gt.

Moreover, the image processor 1c may determine, based on a similarity or similarities of the binarization candidate images Gc to each other, whether or not combining the binarization candidate images Gc is allowable. That is, the image processor 1c does not combine a binarization candidate images Gc whose similarity is lower than or equal to the threshold. That is, the image processor 1c does not use the binarization candidate image(s) Gc significantly different from the other(s) of the binarization candidate images Gc(1) to Gc(N+1) to create the template image Gt.

Thus, the template image creation method of the present variation can create the highly accurate template image Gt including little noise also when the binarization candidate images Gc(1) to Gc(N+1) include a binarization candidate image(s) Gc significantly different from the other(s) of the binarization candidate images Gc(1) to Gc(N+1).

### (6) Fourth Variation

In a template image creation method of a fourth variation, image processing including a combination step, a position correcting step, and a compositing step is performed. The combination step includes performing a combination process of producing, from a plurality of input images, one or a plurality of groups each including two or more input images. The position correcting step includes performing position correction of the two or more input images included in each of the one or the plurality of groups. The compositing step includes combining the two or more input images after the position correction, thereby creating one or a plurality of output images respectively corresponding to the one or the plurality of groups. The image processing is performed by using a plurality of candidate images as the plurality of input images. Then, in the case of the plurality of output images, the image processing is repeated by using the plurality of output images as the plurality of input images until an output image satisfying a predetermined condition is obtained as a result of the image processing.

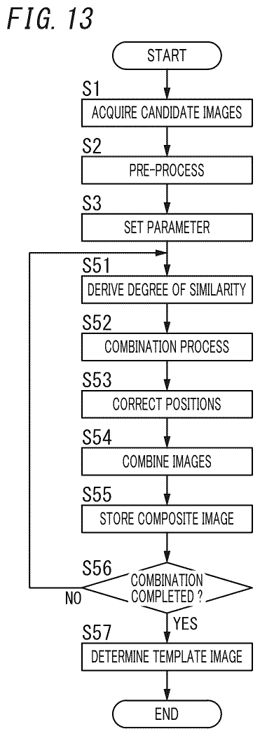

FIG. 13 is a flowchart of the template image creation method of the fourth variation.

First of all, the computer system CS performs an acquisition step S1, a pre-processing step S2, and a parameter setting step S3 in the same manner as explained above.

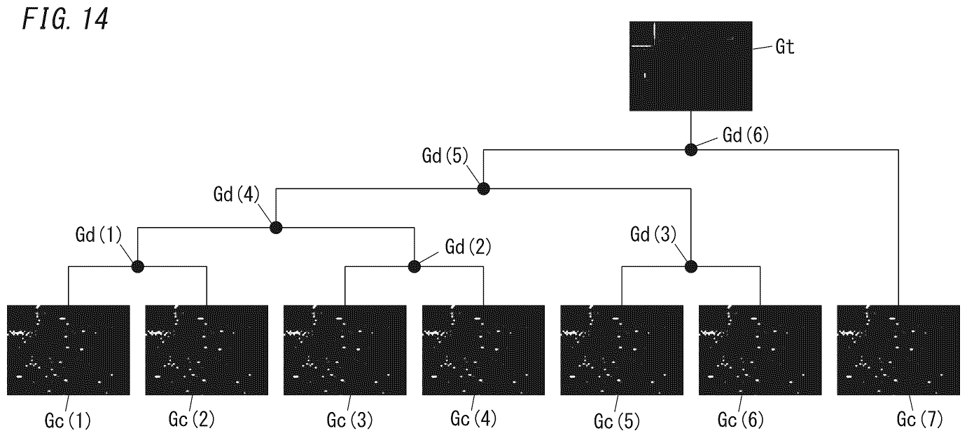

Then, the image processor 1c uses a plurality of binarization candidate images Gc as the plurality of input images. In the present variation, seven binarization candidate images Gc(1) to Gc(7) are used as the plurality of binarization candidate images Gc (see FIG. 14). The image processor 1c obtains similarities of the binarization candidate images Gc(1) to Gc(7) to each other in a similarity deriving step S51.

Next, the image processor 1c sequentially extracts two binarization candidate images Gc from the binarization candidate images Gc(1) to Gc(7) in descending order of similarity and includes the two binarization candidate images Gc thus extracted in the same group in a combination step S52. Specifically, in FIG. 14, the binarization candidate images Gc(1) and Gc(2) are included in the same group, the binarization candidate images Gc(3) and Gc(4) are included in the same group, and the binarization candidate images Gc(5) and Gc(6) are included in the same group.

Next, the image processor 1c performs the position correction of the two binarization candidate images Gc belonging to the same group in a position correcting step S53. Specifically, as shown in FIG. 14, the image processor 1c performs the position correction of the binarization candidate images Gc(1) and Gc(2) belonging to the same group. The image processor 1c performs the position correction of the binarization candidate images Gc(3) and Gc(4) belonging to the same group. The image processor 1c performs the position correction of the binarization candidate images Gc(5) and Gc(6) belonging to the same group.

Next, the image processor 1c combines the two binarization candidate images Gc with each other after the position correction, thereby creating a composite image Gd in a compositing step S54. Specifically, as shown in FIG. 14, the image processor 1c combines the binarization candidate images Gc(1) and Gc(2) after the position correction, thereby creating a composite image Gd(1). The image processor 1c combines the binarization candidate images Gc(3) and Gc(4) after the position correction, thereby creating a composite image Gd(2). The image processor 1c combines the binarization candidate images Gc(5) and Gc(6) after the position correction, thereby creating a composite image Gd(3).

Next, the image processor 1c stores pieces of data on the composite images Gd(1) to Gd(3) in the storage 1b and deletes pieces of data on the binarization candidate images Gc(1) to Gc(6) from the storage 1b in a data storing step S55. In this case, the storage 1b stores data on the binarization candidate image Gc(7) and the pieces of data on the composite images Gd(1) to Gd(3) as pieces of data of output images.

Next, the image processor 1c determines whether or not a compositing process is completed in a completion determining step S56. Specifically, if the storage 1b stores two or more output images, the image processor 1c determines that the compositing process is not completed. If the storage 1b stores one output image, the image processor 1c determines that the compositing process is completed. Here, the storage 1b stores the pieces of data on the binarization candidate image Gc(7) and the composite images Gd(1) to Gd(3) and the number of output images is greater than or equal to two, and therefore, the image processor 1c determines that the compositing process is not completed. When the image processor 1c determines that the compositing process is not completed, the binarization candidate image Gc(7) and the composite images Gd(1) to Gd(3) stored in the storage 1b are used as input images, and the method returns to the similarity deriving step S51.

Then, the image processor 1c obtains similarities of the binarization candidate image Gc(7) and the composite images Gd(1) to Gd(3) to each other in the similarity deriving step S51. Next, the image processor 1c sequentially extracts two images from the binarization candidate image Gc(7) and the composite images Gd(1) to Gd(3) in descending order of similarity in the combination step S52 and includes the two binarization candidate images Gc thus extracted in the same group. Specifically, in FIG. 14, the composite images Gd(1) and Gd(2) are in the same group. The image processor 1c then performs the position correction of the composite images Gd(1) and Gd(2) belonging to the same group in the position correcting step S53. The image processor 1c then combines the two composite images Gd(1) and Gd(2) after the position correction, thereby creating a composite image Gd(4) in the compositing step S54.

Next, the image processor 1c stores data on the composite image Gd(4) in the storage 1b and deletes the pieces of data on the composite images Gd(1) and Gd(2) from the storage 1b in the data storing step S55. As a result, the storage 1b stores the pieces of data on the binarization candidate image Gc(7) and the composite images Gd(3) and Gd(4) as pieces of data on output images.

Next, the image processor 1c determines whether or not the compositing process is completed in the completion determining step S56. Here, the storage 1b stores the pieces of data on the binarization candidate image Gc(7) and the composite images Gd(3) and Gd(4), and the number of output images is greater than or equal to two, and therefore, the image processor 1c determines that the compositing process is not completed. When the image processor 1c determines that the compositing process is not completed, the image processor 1c uses the binarization candidate image Gc(7) and the composite images Gd(3) and Gd(4) stored in the storage 1b as input images, and the method returns to the similarity deriving step S51.

Then, the image processor 1c obtains similarities of the binarization candidate image Gc(7) and the composite images Gd(3) and Gd(4) to each other in the similarity deriving step S51. Next, the image processor 1c sequentially extracts two images from the binarization candidate image Gc(7) and the composite images Gd(3) and Gd(4) in descending order of similarity and includes the two binarization candidate images Gc thus extracted in the same group in the combination step S52. Specifically, in FIG. 14, the composite images Gd(3) and Gd(4) are in the same group. The image processor 1c then performs the position correction of the composite images Gd(3) and Gd(4) belonging to the same group in the position correcting step S53. The image processor 1c then combines the two composite images Gd(3) and Gd(4) after the position correction, thereby creating a composite image Gd(5) in the compositing step S54.

Next, the image processor 1c stores data on the composite image Gd(5) in the storage 1b and deletes the pieces of data on the composite images Gd(3) and Gd(4) from the storage 1b in the data storing step S55. As a result, the storage 1b stores the pieces of data on the binarization candidate image Gc(7) and the composite image Gd(5) as pieces of data on output images.

Next, the image processor 1c determines whether or not the compositing process is completed in the completion determining step S56. Here, the storage 1b stores the pieces of data on the binarization candidate image Gc(7) and the composite image Gd(5), and the number of output images is greater than or equal to two, and therefore, the image processor 1c determines that the compositing process is not completed. When the image processor 1c determines that the compositing process is not completed, the image processor 1c uses the binarization candidate image Gc(7) and the composite image Gd(5) stored in the storage 1b as input images, and the method returns to the similarity deriving step S51.

Then, the image processor 1c obtains a similarity between the binarization candidate image Gc(7) and the composite image Gd(5) in the similarity deriving step S51. Next, the image processor 1c includes the binarization candidate image Gc(7) and the composite image Gd(5) in the same group in the combination step S52. Next, the image processor 1c performs the position correction of the binarization candidate image Gc(7) and the composite image Gd(5) belonging to the same group in the position correcting step S53. Next, the image processor 1c combines the binarization candidate image Gc(7) and the composite image Gd(5) after the position correction, thereby creating a composite image Gd(6) in the compositing step S54.

Next, the image processor 1c stores data on the composite image Gd(6) in the storage 1b and deletes the pieces of data on the binarization candidate image Gc(7) and the composite image Gd(5) from the storage 1b in the data storing step S55. As a result, the storage 1b stores the data on the composite image Gd(6) as data on an output image.

Next, the image processor 1c determines whether or not the compositing process is completed in the completion determining step S56. Here, the storage 1b stores the data on the composite image Gd(6), and the number of output images is one, and therefore, the image processor 1c determines that the compositing process is completed. When the image processor 1c determines that the compositing process is completed, the image processor 1c determines that the composite image Gd(6) stored in the storage 1b is the template image Gt in the determination step S57.

In the present embodiment, the similarity deriving step S51 and the combination step S52 are in each case performed by using the composite image. However, all combinations for a plurality of images may be determined at first by using, for example, hierarchical cluster analysis.

As described above, the template image creation method of the present embodiment creates the template image Gt from the plurality of binarization candidate images Gc displaced from each other in terms of the positions of the target regions Ra1 to Ra6. Specifically, the template image creation method of the present embodiment includes creating the template image Gt by combining the plurality of binarization candidate images Gc after the displacement of the plurality of binarization candidate images Gc is corrected by the position correction using the pattern matching. As a result, the template image creation method of the present embodiment enables a highly accurate template image Gt including little noise to be created also when positions of the test object captured on the plurality of binarization candidate images Gc are not aligned with each other.

### (7) Fifth Variation

A template image creation method of a fifth variation obtains, in the case of the plurality of output images in the fourth variation, a similarity or similarities of the plurality of output images to each other. Then, if the similarity or all the similarities of the plurality of output images to each other are each less than or equal to a similarity threshold, each of the plurality of output images is used as the template image Gt. In this case, even if the features of the target region Ra vary depending on lots of test objects, the accuracy of the template matching can be increased by creating the plurality of template images Gt corresponding to the features.

For example, in FIG. 14, if similarities of the composite images Gd(1) and Gd(2) and the binarization candidate image Gc(7) to each other are each greater than or equal to a predetermined similarity threshold, the method proceeds with the processes in the fourth variation. If the similarities of the composite images Gd(1) and Gd(2) and the binarization candidate image Gc(7) to each other are each less than the predetermined similarity threshold, the composite images Gd(1) and Gd(2) and the binarization candidate image Gc(7) are each used as the template image Gt. In this case, the template image creation system 1 creates three template images Gt as a template set. Moreover, one to two of the three template images may be used as a template set.

### (8) Sixth Variation

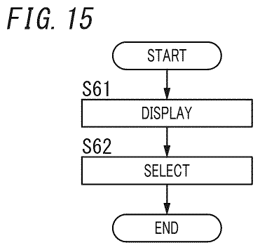

A template image creation method of a sixth variation is based on the fourth variation and further includes a display step S61 and a selection step S62 shown in FIG. 15. The display step S61 includes displaying a plurality of input images and at least one output image on the display unit 1d (see FIG. 2) in a tree structure including nodes which are the plurality of input images and the at least one output image. The selection step S62 includes selecting, as the template image, at least one of the plurality of input images or output images displayed on the display unit 1d.

For example, a difference in production lots, product types, material types, or conditions relating to production and/or inspection of test objects may result in significantly variable appearances of the test objects captured on candidate images. Examples of the appearances include the shape, the pattern, the size, the two-dimensional code printed on the surface, and the like of the test objects.

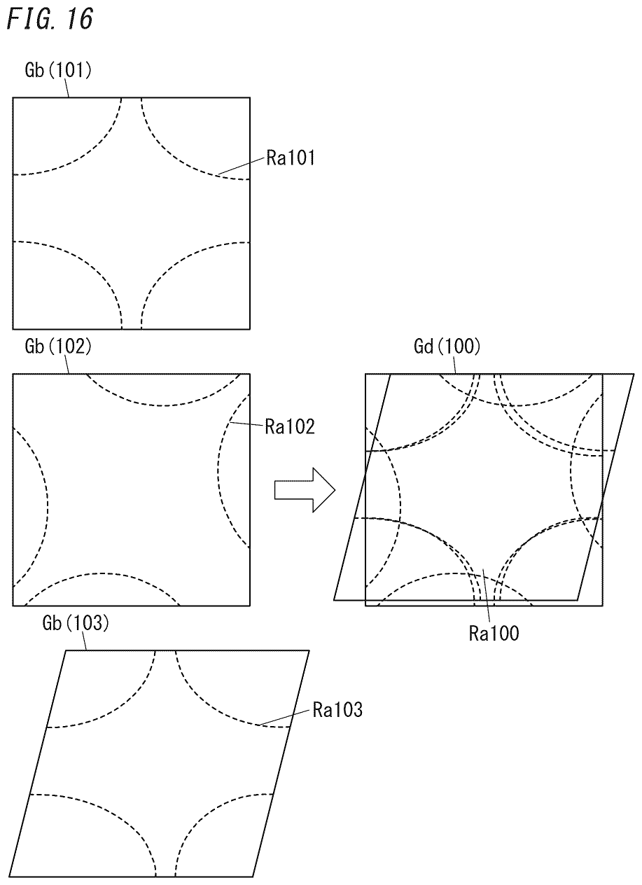

For example, a gradation candidate image Gb(101) in FIG. 16 includes, as a target region Ra101, a region including an image of a test object. A gradation candidate image Gb(102) includes, as a target region Ra102, a region including an image of a test object. A gradation candidate image Gb(103) includes, as a target region Ra103, a region including an image of a test object. The gradation candidate images Gb(101), Gb(102), and Gb(103) are combined together, thereby creating a composite image Gd(100) including a target region Ra100. The target region Ra100 is a region in which the target regions Ra101, Ra102, and Ra103 are combined together. However, the target region Ra101, the target region Ra102, and the target region Ra103 are significantly different from one another, and therefore, each of a similarity between the target region Ra100 and the target region Ra101, a similarity between the target region Ra100 and the target region Ra102, and a similarity between the target region Ra100 and the target region Ra103 is small. Thus, the accuracy of the template image Gt created based on the composite image Gd(100) is low, and the template image Gt includes a lot of noise.

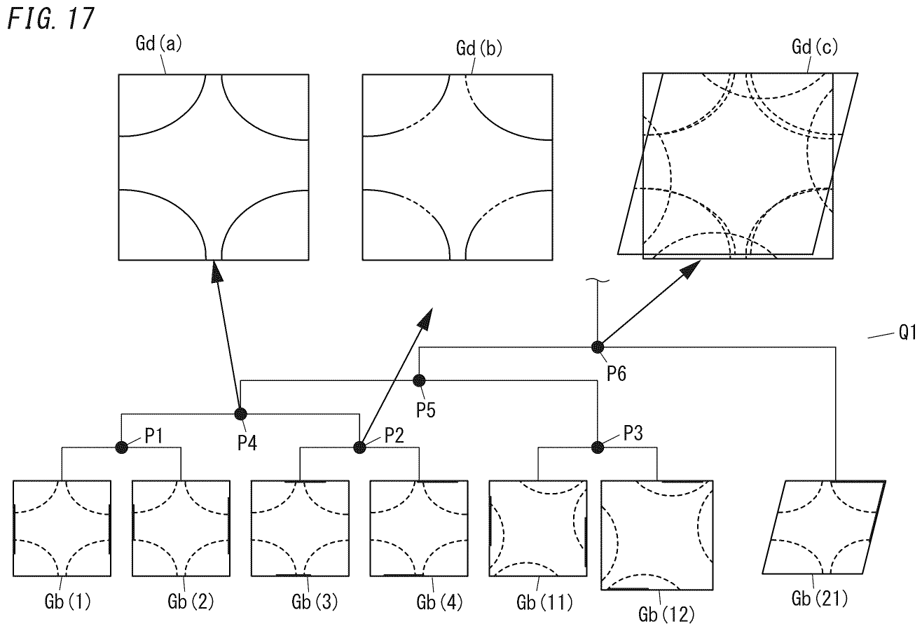

Therefore, the computer system CS uses, as input images, gradation candidate images Gb(1) to Gb(4) and gradation candidate images Gb(11), Gb(12), and Gb(21) including images of test objects shown in FIG. 17 and executes a template image creation method similarly to that of the fourth variation. In this variation, the images of the test object included in the gradation candidate images Gb(1) to Gb(4) are significantly different from the images of the test object included in the gradation candidate images Gb(11) and Gb(12). Moreover, the gradation candidate image Gb(21) is a distorted image, that is, a defective image.

In this case, the computer system CS creates a group including the gradation candidate images Gb(1) and Gb(2), a group including the gradation candidate images Gb(3) and Gb(4), and a group including the gradation candidate images Gb(11) and Gb(12). The computer system CS performs position matching in, and combines, the two gradation candidate images Gb in each group, thereby creating a composite image as an output image of each group. Moreover, the computer system CS uses, as input images, the plurality of composite images to create groups each including two composite images, and performs position matching in, and combines, the composite images in each group, thereby creating a composite image as an output image of each group. The computer system CS repeats the above-described process using the plurality of composite images as the input images and combines also the gradation candidate image Gb(21), thereby eventually creating one composite image.

The display unit 1d displays a tree structure Q1 (see FIG. 17) including nodes which are a plurality of input images and at least one output image. The tree structure Q1 includes nodes P1 to P6 each corresponding to the composite image.

The inspector then gives an operation to the operating unit 1e to select any one of the nodes of the tree structure Q1. For example, when the inspector selects the node P2, the display unit 1d displays a composite image Gd(b) including relatively a lot of noise. When the inspector selects the node P4, the display unit 1d displays a composite image Gd(a) including relatively little noise. When the inspector selects the node P6, the display unit 1d displays a composite image Gd(c) including a whole lot of noise. That is, the inspector can check the composite images by causing the display unit 1d to display the composite images. The inspector then sets a highly accurate composite image including little noise (e.g., the composite image Gd(a)) as the template image Gt.

In the present variation, the inspector does not have to go through a trial-and-error process of repeating parameter tuning and result verification in order to select the template image Gt, and thus, the inspector can efficiently select the template image Gt.

### (9) Seventh Variation

Note that the gradation candidate image Gb and the binarization candidate image Gc are preferably images each having a resolution of 1 μm/pix or lower.

Moreover, the gradation candidate image Gb and the binarization candidate image Gc may be images in each of which the target region Ra is not clearly visible even at the limit of optical zoom.

Furthermore, the gradation candidate image Gb and the binarization candidate image Gc may be images in each of which the feature of the test object is not clearly captured with the resolution of an image-capturing device.

Further, the gradation candidate image Gb and the binarization candidate image Gc each may be either an image obtained by capturing an image of a surface of the test object or a transmission image obtained by capturing an image of the interior of the test object.

Furthermore, the gradation candidate image Gb and the binarization candidate image Gc may be images each of which is captured without performing optical zoom. In this case, a range in which images can be captured is widened, thereby increasing an inspection speed. Moreover, the range of the depth of focus is widened, so that a candidate image with reduced out-of-focus regions can be created.

Further, the gradation candidate image Gb and the binarization candidate image Gc may be gradation images. In this case, noise remaining in the template image Gt after edge detection can be reduced.

Moreover, the candidate image, the composite image, and the template image each may be either the gradation image or a binarization image. For combining the gradation images, an average, a median value, a weighted average, a maximum value, or a minimum value of gradation values of pixels of each gradation images is used as the gradation value of each pixel of the composite image. For combining the binarization images, a logical disjunction or a logical conjunction of gradation values of pixels of each binarization image is used as the gradation value of each pixel of the composite image.

Moreover, a composite image may be subjected to one of, or a combination process of two or more of, a median filter process, a Gaussian filter process, a histogram smoothing process, a normalization process, a standardization process, a binarization process, and an edge detection process to obtain an image, which may be used as the template image.

Moreover, in the compositing step, three or more images may be combined at once.

### (10) Summary

A template image creation method of a first aspect according to the embodiment creates a template image (Gt) from a plurality of candidate images (Gb, Gc) including target regions (Ra) each including an image of a test object. The template image creation method includes creating at least one template image (Gt) by performing position correction by pattern matching to match a position of the target region (Ra) between the plurality of candidate images (Gb, Gc) and sequentially combining the plurality of candidate images (Gb, Gc).

Thus, the template image creation method enables a highly accurate template image (Gt) including little noise to be created also when positions of images of the test object in the plurality of candidate images (Gb, Gc) are not aligned with each other.

A template image creation method of a second aspect according to the embodiment referring to the first aspect preferably further includes a parameter setting step (S3) of setting a parameter relating to the position correction.

Thus, the template image creation method enables the direction for the position correction to be limited, thereby suppressing a calculation cost required for the position correction.

A template image creation method of a third aspect according to the embodiment referring to the first or second aspect preferably includes an extraction step (S4, S23), a position correcting step (S5, S26), a compositing step (S6, S27), and a determination step (S10, S34, S43). The extraction step (S4, S23) includes sequentially extracting one candidate image (Gb) from the plurality the candidate images (Gb). The position correcting step (S5, S26) includes performing, each time the one candidate image is extracted in the extraction step (S4, S23), the position correction of all of the candidate images (Gb) extracted in the extraction step (S4, S23). The compositing step (S6, S27) includes creating a composite image (Gd) by combining, each time the position correction is performed, all of the candidate images (Gb) after the position correction. The determination step (S10, S34, S43) includes determining that a composite image (Gd) created in the compositing step (S6, S27) performed for a last time of the compositing step (S6, S27) performed for a plurality of number of times is the template image (Gt).

Thus, the template image creation method enables a highly accurate template image (Gt) including little noise to be created also when positions of images of the test object in the plurality of candidate images (Gb, Gc) are not aligned with each other.

In a template image creation method of a fourth aspect according to the embodiment referring to the third aspect, when an Mth candidate image (Gb) is extracted from the plurality of candidate images (Gb) in the extraction step (S4, S23), the position correcting step (S5, S26) preferably includes matching, by the pattern matching, a position of a target region (Ra) of a composite image (Gd) obtained by combining first to (M−1)th candidate images (Gb) and the position of the target region (Ra) of the Mth candidate image (Gb) with each other, where M is a positive integer. The compositing step (S6, S27) includes combining the composite image (Gd) and the Mth candidate image (Gc).

Thus, the template image creation method enables a highly accurate template image (Gt) including little noise to be created also when positions of images of the test object in the plurality of candidate images (Gb, Gc) are not aligned with each other.

In a template image creation method of a fifth aspect according to the embodiment referring to any one of the first to fourth aspects, at least one of whether or not combining the plurality of candidate images (Gc) is allowable or a sequential order of combining the plurality of candidate images (Gc) is set based on a similarity or similarities of the plurality of candidate images (Gc) to each other.

Thus, the template image creation method optimizes at least one of whether or not the combining the plurality of binarization candidate images (Gc) is allowable or the sequential order of combining the plurality of binarization candidate images (Gc), and therefore, the template image creation method enables a highly accurate template image (Gt) including little noise to be created also when the plurality of binarization candidate images (Gc) includes a binarization candidate image (Gc) including a lot of noise.

In a template image creation method of a sixth aspect according to the embodiment referring to the first or second aspect, image processing including a combination step (S52), a position correcting step (S53), and a compositing step (S54) is preferably performed. The combination step (S52) includes performing a combination process of producing, from a plurality of input images, one or a plurality of groups each including two or more input images. The position correcting step (S53) includes performing position correction of the two or more input images included in each of the one or the plurality of groups. The compositing step (S54) includes combining the two or more input images after the position correction to create one or a plurality of output images respectively corresponding to the one or the plurality of groups. Then, in a case of the plurality of output images after the image processing is performed by using the plurality of candidate images (Gc) as the plurality of input images, the image processing is repeated by using the plurality of output images as the plurality of input images until an output image satisfying a predetermined condition is obtained as a result of the image processing.

Thus, the template image creation method enables a highly accurate template image (Gt) including little noise to be created also when positions of images of the test object in the plurality of candidate images (Gb, Gc) are not aligned with each other.

In a template image creation method of a seventh aspect according to the embodiment referring to the sixth aspect, preferably, similarities of the plurality of input images to each other are obtained, the two or more input images are sequentially extracted from the plurality of input images in descending order of similarity, and the two or more input images thus extracted are included in a same group.

Thus, the template image creation method optimizes combining the plurality of binarization candidate images (Gc), thereby enabling a highly accurate template image (Gt) including little noise to be created also when the plurality of binarization candidate images (Gc) includes a binarization candidate image (Gc) including a lot of noise.

In a template image creation method of an eighth aspect according to the embodiment referring to the sixth or seventh aspect, In the case of the plurality of output images, a similarity or similarities of the plurality of output images to each other are obtained, and when the similarity or all of the similarities of the plurality of output images to each other are each less than a similarity threshold, each of the plurality of output images is preferably used as the template image (Gt).

Thus, even when features of the target region (Ra) varies depending on lots of test objects, the template image creation method enables the accuracy of the template matching to be increased by creating the plurality of template images (Gt) corresponding to the respective features.

A template image creation method of a ninth aspect according to the embodiment referring to any one of the sixth to eighth aspects preferably further includes a display step (S61) and a selection step (S62). The display step (S61) includes displaying, on a display unit (1d), the plurality of input images and the one or the plurality of output images in a tree structure (Q1) including nodes which are the plurality of input images and the one or the plurality of output images. The selection step (S62) includes selecting, as the template image (Gt), at least one of the plurality of input images or the one or the plurality of output images displayed on the display unit (1d).

Thus, in the template image creation method, an inspector does not have to go through a trial-and-error process of repeating parameter tuning and result verification in order to select a template image (Gt), and thus, the inspector can efficiently select the template image (Gt).

A template image creation system (1) of a tenth aspect according to the embodiment is configured to create a template image (Gt) from a plurality of candidate images (Gc) each including a target region (Ra) including an image of a test object. The template image creation system (1) includes an image processor (1c). The image processor (1c) is configured to create at least one template image (Gt) by performing position correction by pattern matching to match a position of the target region (Ra) between the plurality of candidate images (Gc) and sequentially combining the plurality of candidate images (Gb).

Thus, the template image creation system (1) enables a highly accurate template image (Gt) including little noise also when positions of images of the test object in the plurality of candidate images (Gb, Gc) are not aligned with each other.

A template image creation system (1) of an eleventh aspect according to the embodiment referring to the tenth aspect preferably further includes an image acquirer (1a) configured to acquire the plurality of candidate images (Gb, Gc).

Thus, template image creation system (1) is configured to acquire the plurality of candidate images from an external database, a camera, a storage medium, or the like.

A program of a twelfth aspect according to the embodiment is configured to cause a computer system (CS) to execute the template image creation method of any one of the first to ninth aspects.

Thus, the program enables a highly accurate template image (Gt) including little noise to be created also when positions of images of the test object in the plurality of candidate images (Gb, Gc) are not aligned with each other.

### REFERENCE SIGNS LIST

S3 Parameter Setting Step
S4, S23 Extraction Step
S5, S26 Position Correcting Step
S6, S27 Compositing Step

S10, S34, S43 Determination Step
S52 Combination Step
S53 Position Correcting Step
S54 Compositing Step
S61 Display Step
S62 Selection Step
Ra Target Region
Gb Gradation Candidate Image (Candidate Image)
Gc Binarization Candidate Image (Candidate Image)
Gd Composite Image
Gt Template Image
Q1 Tree Structure
CS Computer System
M Positive Integer
1 Template Image Creation System
1a Image Acquirer
1c Image Processor
1d Display Unit

1. A template image creation method for creating a template image from a plurality of candidate images each including a target region including an image of a test object, the template image creation method comprising:
creating at least one template image by
performing position correction by pattern matching to match a position of the target region between the plurality of candidate images and
sequentially combining the plurality of candidate images.

2. The template image creation method of claim 1 further comprising a parameter setting step of setting a parameter relating to the position correction.

3. The template image creation method of claim 1, further comprising:
an extraction step of sequentially extracting one candidate image from the plurality of candidate images;
a position correcting step of performing, each time the one the plurality of candidate images is extracted in the extraction step, the position correction of all of the candidate images extracted in the extraction step;
a compositing step of creating a composite image by combining, each time the position correction is performed, all of the candidate images after the position correction; and
a determination step of determining that a composite image created in the compositing step performed for a last time of the compositing step performed for a plurality of number of times is as the template image.

4. The template image creation method of claim 3, wherein
when an Mth candidate image is extracted from the plurality of candidate images in the extraction step,
the position correcting step includes matching, by the pattern matching, a position of a target region of a composite image obtained by combining first to (M−1)th candidate images and the position of the target region of the Mth candidate image with each other, where M is a positive integer, and
the compositing step includes combining the composite image and the Mth candidate image.

5. The template image creation method of claim 1, wherein
at least one of whether or not combining the plurality of candidate images is allowable or a sequential order of combining the plurality of candidate images is set based on a similarity or similarities of the plurality of candidate images to each other.

6. The template image creation method of claim 1, wherein
image processing is performed, the image processing including
a combination step of performing a combination process of producing, from a plurality of input images, one or a plurality of groups each including two or more input images,
a position correcting step of performing the position correction of the two or more input images included in each of the one or the plurality of groups, and
a compositing step of combining the two or more input images after the position correction to create one or a plurality of output images respectively corresponding to the one or the plurality of groups,
in a case of the plurality of output images after the image processing is performed by using the plurality of candidate images as the plurality of input images, the image processing is repeated by using the plurality of output images as the plurality of input images until an output image satisfying a predetermined condition is obtained as a result of the image processing.

7. The template image creation method of claim 6, wherein
similarities of the plurality of input images to each other are obtained,
the two or more input images are sequentially extracted from the plurality of input images in descending order of similarity, and
the two or more input images thus extracted are included in a same group.

8. The template image creation method of claim 6, wherein
in the case of the plurality of output images,
a similarity or similarities of the plurality of output images to each other are obtained, and
when the similarity or all of the similarities of the plurality of output images to each other are each less than a similarity threshold, each of the plurality of output images is used as the template image.

9. The template image creation method of claim 6, further comprising:
a display step of displaying, on a display unit, the plurality of input images and the one or the plurality of output images in a tree structure including nodes which are the plurality of input images and the one or the plurality of output images; and
a selection step of selecting, as the template image, at least one of the plurality of input images or the one or the plurality of output images displayed on the display unit.

10. A template image creation system for creating a template image from a plurality of candidate images each including a target region including an image of a test object, the template image creation system comprising an image processor configured to create at least one template image by performing position correction by pattern matching to match a position of the target region the plurality of candidate images and sequentially combining the plurality of candidate images.

11. The template image creation system of claim 10, further comprising an image acquirer configured to acquire the plurality of candidate images.

12. A non-transitory storage medium storing a program that is configured to cause a computer system to execute the template image creation method of claim 1.

13. The template image creation method of claim 2, further comprising:
an extraction step of sequentially extracting one candidate image from the plurality of candidate images;
a position correcting step of performing, each time the one the plurality of candidate images is extracted in the extraction step, the position correction of all of the candidate images extracted in the extraction step;
a compositing step of creating a composite image by combining, each time the position correction is performed, all of the candidate images after the position correction; and
a determination step of determining that a composite image created in the compositing step performed for a last time of the compositing step performed for a plurality of number of times is as the template image.

14. The template image creation method of claim 2, wherein
at least one of whether or not combining the plurality of candidate images is allowable or a sequential order of combining the plurality of candidate images is set based on a similarity or similarities of the plurality of candidate images to each other.

15. The template image creation method of claim 3, wherein
at least one of whether or not combining the plurality of candidate images is allowable or a sequential order of combining the plurality of candidate images is set based on a similarity or similarities of the plurality of candidate images to each other.

16. The template image creation method of claim 4, wherein
at least one of whether or not combining the plurality of candidate images is allowable or a sequential order of combining the plurality of candidate images is set based on a similarity or similarities of the plurality of candidate images to each other.

17. The template image creation method of claim 2, wherein
image processing is performed, the image processing including
a combination step of performing a combination process of producing, from a plurality of input images, one or a plurality of groups each including two or more input images,
a position correcting step of performing the position correction of the two or more input images included in each of the one or the plurality of groups, and
a compositing step of combining the two or more input images after the position correction to create one or a plurality of output images respectively corresponding to the one or the plurality of groups,
in a case of the plurality of output images after the image processing is performed by using the plurality of candidate images as the plurality of input images, the image processing is repeated by using the plurality of output images as the plurality of input images until an output image satisfying a predetermined condition is obtained as a result of the image processing.

18. The template image creation method of claim 7, wherein
in the case of the plurality of output images,
a similarity or similarities of the plurality of output images to each other are obtained, and
when the similarity or all of the similarities of the plurality of output images to each other are each less than a similarity threshold, each of the plurality of output images is used as the template image.

19. The template image creation method of claim 7, further comprising:
a display step of displaying, on a display unit, the plurality of input images and the one or the plurality of output images in a tree structure including nodes which are the plurality of input images and the one or the plurality of output images; and
a selection step of selecting, as the template image, at least one of the plurality of input images or the one or the plurality of output images displayed on the display unit.

20. The template image creation method of claim 8, further comprising:
a display step of displaying, on a display unit, the plurality of input images and the one or the plurality of output images in a tree structure including nodes which are the plurality of input images and the one or the plurality of output images; and
a selection step of selecting, as the template image, at least one of the plurality of input images or the one or the plurality of output images displayed on the display unit.
